(19) United States
(12) Patent Application Publication
(10) Pub. No.: US 2023/0034234 A1
(43) Pub. Date: Feb. 2, 2023

(54) Crosswalk Light Device

(71) Applicant: Brian Baker, Springfield, TN (US)

(72) Inventor: Brian Baker, Springfield, TN (US)

(21) Appl. No.: 17/835,040

(22) Filed: Jun. 8, 2022

Related U.S. Application Data
(60) Provisional application No. 63/226,313, filed on Jul. 28, 2021.

(51) Int. Cl. F21S 8/08; F21V 23/04; G08G 1/005

(52) U.S. Cl. CPC F21S 8/088; F21V 23/0471; G08G 1/005; F21W 2131/103

(57) ABSTRACT

The present invention relates to a novel crosswalk light device. The device is designed to ensure that a crosswalk is highly visible during nighttime and other lowlight hours of the day to prevent accidents. The device comprises an LED floodlight mounted on top of a pedestrian crosswalk signal. The light illuminates the crosswalk area during the walking phase of the crosswalk. The light is wired through a series of relays and a capacitor to hold steady voltage. Accordingly, the device maintains an optimal level of safety for both pedestrians and motorists.

### CROSS-REFERENCE TO RELATED APPLICATION

The present application claims priority to, and the benefit of, U.S. Provisional Application No. 63/226,313, which was filed on Jul. 28, 2021 and is incorporated herein by reference in its entirety.

### FIELD OF THE INVENTION

The present invention relates generally to the field of crosswalk light devices. More specifically, the present invention relates to an improved crosswalk light device that provides users with a safety device that illuminates a crosswalk for walking pedestrians. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in crosswalk lights for illuminating crosswalks at night. Current pedestrian crosswalk designations are inadequate for many locations and lighting conditions. For example, stripes painted on the surface of the pavement are difficult to see even under optimum circumstances, and crosswalk caution signs are all too often lost in the background clutter of trees, business signs, buildings, and temporarily parked delivery trucks and vans. Street lighting systems and traffic signals are useful to help designate crosswalk locations, but these can be extremely expensive to install and maintain and, therefore, are reserved for only the busiest locations.

Furthermore, roadway crosswalks at night may be dark and dangerous. Thus, despite the walk and stop lights, drivers may have trouble seeing a person crossing in the road and may have trouble seeing where the crosswalk starts and ends. Accordingly, pedestrian injuries and fatalities can occur, even when pedestrians are using a crosswalk appropriately. It is therefore apparent that an improved device needs to be developed for alerting traffic to the presence of a pedestrian in a crosswalk, even in low light conditions such as at night.

Accordingly, a crosswalk warning light device that is able to detect when a pedestrian has entered a crosswalk and accordingly activate a light that warns drivers of oncoming traffic of the presence of a pedestrian in the crosswalk is needed. Further, the device provides warning lights that are highly visible to oncoming traffic during periods of poor visibility, such as nighttime, fog and/or inclement weather. Finally, the device illuminates a crosswalk area, including the pedestrians within the crosswalk area.

Therefore, there exists a long-felt need in the art for a crosswalk light device that provides users with a safety device designed to illuminate a crosswalk for walking pedestrians and motorists. There is also a long-felt need in the art for a crosswalk light device that ensures the crosswalk is highly visible during nighttime and other lowlight hours of the day to prevent serious accidents and injuries. Further, there is a long-felt need in the art for a crosswalk light device that features an LED floodlight mounted on top of a pedestrian crosswalk signal. Moreover, there is a long-felt need in the art for a device that illuminates the crosswalk area when it is safe to walk, allowing users to easily see where the crosswalk is and where people are walking. Further, there is a long-felt need in the art for a crosswalk light device that maintains an appropriate level of roadway safety and ensures that both walking pedestrians and motorists are aware of individuals in the crosswalk. Finally, there is a long-felt need in the art for a crosswalk light device that illuminates a crosswalk area and maintains an optimal level of safety for both pedestrians and motorists.

The subject matter disclosed and claimed herein, in one embodiment thereof, comprises a crosswalk light device. The device is designed to ensure that a crosswalk is highly visible during nighttime and other lowlight hours of the day to prevent accidents. The device comprises an LED floodlight mounted on top of a pedestrian crosswalk signal. The light illuminates the crosswalk area during the walking phase of the crosswalk. The light is wired through a series of relays and a capacitor to hold steady voltage. Accordingly, the device maintains an optimal level of safety for both pedestrians and motorists.

In this manner, the crosswalk light device of the present invention accomplishes all of the foregoing objectives and provides users with a device that prevents pedestrians from becoming injured while walking in a crosswalk at night or in other lowlight conditions. The device allows a user to cross a road using a crosswalk during nighttime hours without worry of accidents. The device maintains an appropriate level of roadway safety for both pedestrians and motorists.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a crosswalk light device. The device is designed to ensure that a crosswalk is highly visible during nighttime and other lowlight hours of the day to prevent accidents. The device comprises an LED floodlight mounted on top of a pedestrian crosswalk signal. The light illuminates the crosswalk area during the walking phase of the crosswalk. The light is wired through a series of relays and a capacitor to hold steady voltage. Accordingly, the device maintains an optimal level of safety for both pedestrians and motorists.

The crosswalk light device provides a low-cost traffic warning system which is self-contained, easily retrofitted to existing crosswalk locations, and designed to alert approaching vehicle traffic to the presence of a pedestrian in a crosswalk. The light source is activated by the pedestrian, either by manual switch or by sensor, before he or she enters the crosswalk. Specifically, the crosswalk light device detects a pedestrian entering the crosswalk and activates a light that is aimed across the street in order to project a beam of light from one end of the crosswalk to the other, thus a motorist sees this beam of light and is warned of the presence of a pedestrian in the crosswalk.

In one embodiment, the light source is any suitable light source as is known in the art, such as a laser, a strobe light, a flood light, an incandescent light, or an LED light, etc. Also, in another embodiment, a second light source, disposed at the opposite end of the crosswalk, provides a second beam of light, aimed substantially co-linearly with the first. This allows at least a partial beam of light at each end of the crosswalk in the event a pedestrian blocks the first beam of light. However, those skilled in the art will recognize that a single light source mounted on a pedestrian crosswalk signal may be utilized. It will also be recognized by those skilled in the art, that in embodiments using a plurality of light sources, separate light sources may illuminate smaller areas than the crosswalk area, but which combine to illuminate the entire crosswalk area.

The level of illumination can be designed to conform with existing illumination standards for traffic control devices and further modified for either daytime or nighttime use. An ambient light sensing circuit may be provided to adjust light intensity to dynamically compensate for poor visibility and night operating conditions.

In one embodiment, the device is timed so as to deactivate the light source after a predetermined interval of time. Specifically, the light controller deactivates the light source after a predetermined amount of time. If a pedestrian is detected by the sensor, then the light controller activates the appropriate light source and sets a timer. If the predetermined amount of time elapses prior to a subsequent pedestrian being detected, then the light source is deactivated. However, if a subsequent pedestrian is detected entering the crosswalk, the timer is reset. In this fashion, the light controller does not deactivate the light source while a pedestrian is in the crosswalk.

In one embodiment, the light source is controlled by a light controller, which receives signals from a sensor. The light controller may be based on a single board embedded computer, custom micro-controller system, or programmable logic controller (PLC) to control all operation of the lighting device. Optically isolated inputs and outputs may also provide monitoring and control of the device. In one embodiment, the controller can be accessed remotely via radio or telephone from a central computer. This could be useful in uploading new parameters to the controller, downloading historical files from the controller, or remotely activating the device without actually being at the site.

In another embodiment, the light source is energized by a power source. It will be recognized by those skilled in the art that the power source may be hardwired to the same power source as existing traffic controls, hardwired directly to main power leads, battery-powered or solar-powered. For example, the lighting device may be powered by a twelve-volt power source consisting of a solar panel, maintenance free battery and a charging circuit. A solar panel provides all the necessary power for operating the device while a maintenance free battery provides backup power during night or low light conditions. The solar panel can be sized to ensure adequate current to power to the lighting device while charging the maintenance free battery during daylight hours. The maintenance free battery can be sized to ensure adequate reserve current to power the lighting device during nighttime hours when the solar panel is not in operation.

As stated supra, the light source can be activated by the pedestrian, either by manual switch or by sensor, before he or she enters the crosswalk. Further, a switch can be provided on both sides of the street to allow activation of the system by a pedestrian. The switches can be a mechanical pole-mounted design, or proximity actuated switches (i.e., infrared sensors), a pressure-sensitive pad, or any other suitable activation device or sensor as is known in the art.

In one embodiment, the sensor is an infrared detector including an infrared light (IR) source, a reflector, and an IR detector. The IR source and detector are positioned with respect to each other on one side of the crosswalk with the reflector positioned at the opposite side of the crosswalk, such that an IR beam is directed across the crosswalk to the reflector, and back to the detector. When the IR beam is broken, such as by the entrance of a pedestrian in the crosswalk, the IR detector senses the absence of the IR light and thus indicates the presence of the pedestrian in the crosswalk. Specifically, as a pedestrian steps into the crosswalk, the IR beam is momentarily broken. The infrared sensor then generates a signal which activates the light source. The light source illuminates an area, including at least the crosswalk area, defined by the opposing sides and opposite ends of the crosswalk. Thus, a pedestrian in the area will be illuminated by the light source and will be visible to oncoming traffic.

In one embodiment, the light source of the device is mounted on top of a pedestrian crosswalk signal. However, the light source can be mounted in any suitable place as is known in the art, as long as the light source is visible to motorists driving by. Further, the light source is mounted to the crosswalk signal via any suitable securing means as is known in the art, such as screws, nails, glue, etc.

In a preferred embodiment of the device, the area extends the entire length of the crosswalk so that a driver will be able to see pedestrians in the driver's lane, as well as pedestrians about to enter that lane. Further, the area is wider than the crosswalk in order to account for the height of pedestrians near the boundary of the crosswalk.

In one embodiment, the device is adapted to be a portable device.

In one embodiment, the device can include data storage circuitry to collect additional data, such as the number of pedestrians activating the device, the direction of travel by the pedestrian and the number of vehicles approaching or passing by the device by time of day. The inventive device may include report generation capability which can be useful in determining how frequently the crosswalk is used and the heavy or light usage time periods. These capabilities can be expanded to include other data which the device owner may find useful in preparing future strategies.

In yet another embodiment, the crosswalk light device is manufactured from UV-stabilized plastic or polymers, such as polypropylene or acrylonitrile-butadiene-styrene (ABS), metals, etc.

In yet another embodiment, the crosswalk light device is manufactured from a material that is water resistant.

In another embodiment, the crosswalk light device comprises a plurality of indicia.

In yet another embodiment, a method of illuminating a crosswalk during nighttime hours for pedestrians to cross safely is described. The method includes the steps of providing a crosswalk light device comprising an LED floodlight mounted on top of a pedestrian crosswalk signal. The method also comprises when the walk phase is lit, illuminating the crosswalk via the LED floodlight mounted on the pedestrian crosswalk signal. Further, the method comprises when the no-walk phase is lit, not illuminating the crosswalk. Finally, when illuminated, crossing the road utilizing the illuminated crosswalk.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the crosswalk light device of the present invention secured to a crosswalk sign in accordance with the disclosed architecture;

FIG. 2 illustrates a side perspective view of one embodiment of the crosswalk light device of the present invention secured to a crosswalk sign in accordance with the disclosed architecture;

FIG. 3 illustrates a front perspective view of one embodiment of the crosswalk light device of the present invention not lit up during a no-walk phase in accordance with the disclosed architecture;

FIG. 4 illustrates a front perspective view of one embodiment of the crosswalk light device of the present invention lit up during a walk phase in accordance with the disclosed architecture;

FIG. 5 illustrates a front perspective view of one embodiment of the crosswalk light device of the present invention in use in accordance with the disclosed architecture; and

FIG. 6 illustrates a flowchart showing the method of illuminating a crosswalk during nighttime hours for pedestrians to cross safely in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a crosswalk light device that provides users with a safety device designed to illuminate a crosswalk for walking pedestrians and motorists. There is also a long-felt need in the art for a crosswalk light device that ensures the crosswalk is highly visible during nighttime and other lowlight hours of the day to prevent serious accidents and injuries. Further, there is a long-felt need in the art for a crosswalk light device that features an LED floodlight mounted on top of a pedestrian crosswalk signal. Moreover, there is a long-felt need in the art for a device that illuminates the crosswalk area when it is safe to walk, allowing users to easily see where the crosswalk is and where people are walking. Further, there is a long-felt need in the art for a crosswalk light device that maintains an appropriate level of roadway safety and ensures both walking pedestrians and motorists are aware of people in the crosswalk. Finally, there is a long-felt need in the art for a crosswalk light device that illuminates a crosswalk area and maintains an optimal level of safety for both pedestrians and motorists.

The present invention, in one exemplary embodiment, is a novel crosswalk light device. The device is designed to ensure that a crosswalk is highly visible during nighttime and other lowlight hours of the day to prevent accidents. The device comprises an LED floodlight mounted on top of a pedestrian crosswalk signal. The light illuminates the crosswalk area during the walking phase of the crosswalk. The light is wired through a series of relays and a capacitor to hold steady voltage. Accordingly, the device maintains an optimal level of safety for both pedestrians and motorists. The present invention also includes a novel method of illuminating a crosswalk during nighttime hours for pedestrians to cross safely. The method includes the steps of providing a crosswalk light device comprising an LED floodlight mounted on top of a pedestrian crosswalk signal. The method also comprises when the walk phase is lit, illuminating the crosswalk via the LED floodlight mounted on the pedestrian crosswalk signal. Further, the method comprises when the no-walk phase is lit, not illuminating the crosswalk. Finally, when illuminated, crossing the road utilizing the illuminated crosswalk.

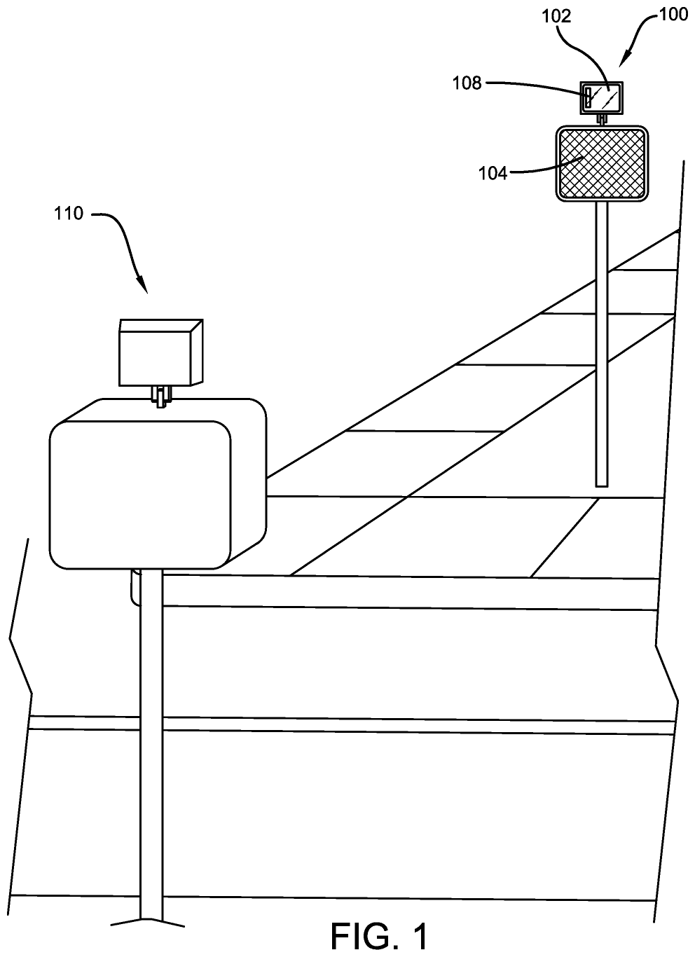

Referring initially to the drawings, FIG. 1 illustrates a perspective view of one embodiment of the crosswalk light device 100 of the present invention. In the present embodiment, the crosswalk light device 100 is an improved crosswalk light device that maintains roadway safety for both pedestrians and motorists. The device 100 is especially designed to allow any motorist, pedestrian, etc., or any other suitable user as is known in the art, to ensure that a crosswalk is highly visible during nighttime and other lowlight hours of the day to prevent accidents. More specifically, the device 100 comprises a light source 102 that is mounted on top of a pedestrian crosswalk signal 104. The light source 102 illuminates the crosswalk area (not shown) during the walking phase of the crosswalk signal 104. The light source 102 is wired through a series of relays and a capacitor to hold steady voltage. Accordingly, the device 100 maintains an optimal level of safety for both pedestrians and motorists.

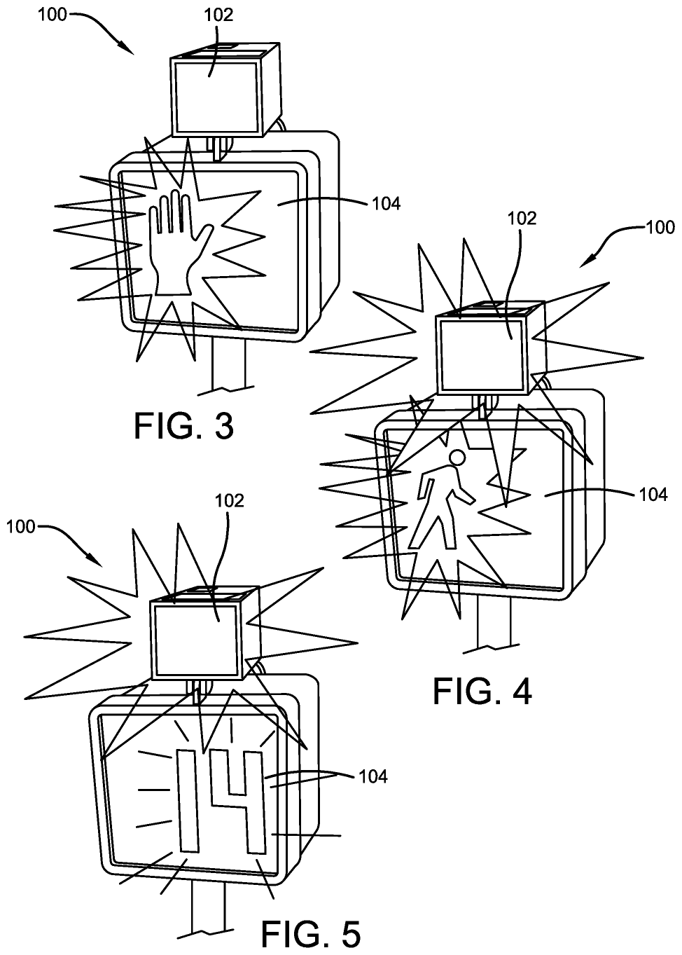

The crosswalk light device 100 provides a low-cost traffic warning system which is self-contained, easily retrofitted to existing crosswalk locations and designed to alert approaching vehicle traffic to the presence of a pedestrian in a crosswalk. The light source 102 is activated by the pedestrian, either by manual switch 106 or by sensor 108, before he or she enters the crosswalk. Specifically, the crosswalk light device 100 detects a pedestrian entering the crosswalk and activates a light source 102 that is aimed across the street in order to project a beam of light from one end of the crosswalk to the other, thus a motorist sees this beam of light and is warned of the presence of a pedestrian in the crosswalk. Further, the crosswalk light device 100 can be in communication with the pedestrian crosswalk signal 104, such that when the walk sign is lit, the light source 102 is activated during the entire walking phase of the crosswalk signal 104 (see FIGS. 4-5). Additionally, if the no-walk sign is lit, the light source 102 is not activated (see FIG. 3).

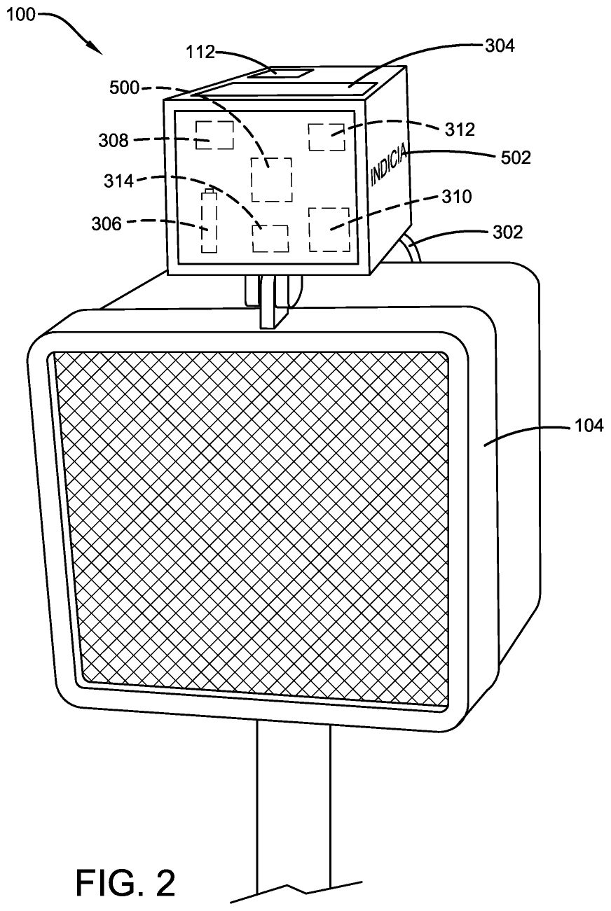

As shown in FIG. 2, the light source 102 is any suitable light source as is known in the art, such as a laser, a strobe light, a flood light, an incandescent light, or an LED light, etc. In a preferred embodiment, the light source 102 is an LED floodlight. Also, in another embodiment, a second light source 110, disposed at the opposite end of the crosswalk, provides a second beam of light, aimed substantially co-linearly with the first. This allows at least a partial beam of light at each end of the crosswalk in the event a pedestrian blocks the first beam of light. However, those skilled in the art will recognize that a single light source 102 mounted on a pedestrian crosswalk signal 104 may be utilized. It will also be recognized by those skilled in the art, that in embodiments using a plurality of light sources 102, 110, separate light sources may illuminate smaller areas of the crosswalk area, but which combine to illuminate the entire crosswalk area.

Furthermore, the level of illumination can be designed to conform with existing illumination standards for traffic control devices and further modified for either daytime or nighttime use. An ambient light sensing circuit 112 may be provided to adjust light intensity to dynamically compensate for poor visibility and night operating conditions.

As shown in FIG. 3, the light source 102 is controlled by a light controller 300, which receives signals from a sensor 108. The light controller 300 may be based on a single board embedded computer, custom micro-controller system, or programmable logic controller (PLC) to control all operation of the lighting device 100. Optically isolated inputs and outputs may also provide monitoring and control of the device 100. In one embodiment, the controller 300 can be accessed remotely via radio or telephone from a central computer (not shown). This could be useful in uploading new parameters to the controller, downloading historical files from the controller, or remotely activating the device 100 without actually being at the site.

In another embodiment, the light source 102 is energized by a power source 302. It will be recognized by those skilled in the art that the power source may be hardwired to the same power source as existing traffic controls, hardwired directly to main power leads, battery-powered or solar-powered. For example, the lighting device 100 may be powered by a twelve-volt power source consisting of a solar panel 304, maintenance free battery 306 and a charging circuit 308. A solar panel 304 provides all the necessary power for operating the device 100 while a maintenance free battery 306 provides backup power during night or low light conditions. The solar panel 304 can be sized to ensure adequate current to power the lighting device 100 while charging the maintenance free battery 306 during daylight hours. The maintenance free battery 306 can be sized to ensure adequate reserve current to power the lighting device 100 during nighttime hours when the solar panel 304 is not in operation.

As stated supra, the light source 102 can be activated by the pedestrian, either by manual switch or by sensor 108 before he or she enters the crosswalk. Further, a switch 106 can be provided on both sides of the street to allow activation of the device 100 by a pedestrian. The switches 106 can be a mechanical pole-mounted design, or proximity actuated switches (i.e., infrared sensors 108), a pressure-sensitive pad, or any other suitable activation device or sensor 108 as is known in the art.

In one embodiment, the sensor 108 is an infrared detector including an infrared light (IR) source 310, a reflector 312 and an IR detector 314. The IR source 310 and detector 314 are positioned with respect to each other on one side of the crosswalk, with the reflector 312 positioned at the opposite side of the crosswalk, such that an IR beam (not shown) is directed across the crosswalk to the reflector 312, and back to the detector 314. When the IR beam is broken, such as by the entrance of a pedestrian in the crosswalk, the IR detector 314 senses the absence of the IR light and thus indicates the presence of the pedestrian in the crosswalk. Specifically, as a pedestrian steps into the crosswalk, the IR beam is momentarily broken. The infrared sensor 108 then generates a signal which activates the light source 102. The light source 102 illuminates an area, including at least the crosswalk area, defined by the opposing sides and opposite ends of the crosswalk. Thus, a pedestrian in the area will be illuminated by the light source 102 and will be visible to oncoming traffic.

As shown in FIG. 4, the device 100 is timed so as to deactivate the light source 102 after a predetermined interval of time. Specifically, the light controller 300 deactivates the light source 102 after a predetermined amount of time. If a pedestrian is detected by the sensor 108, then the light controller 300 activates the appropriate light source 102 and sets a timer. If the predetermined amount of time elapses prior to a subsequent pedestrian being detected, then the light source 102 is deactivated. However, if a subsequent pedestrian is detected entering the crosswalk, the timer is reset. In this fashion, the light controller 300 does not deactivate the light source 102 while a pedestrian is in the crosswalk.

Furthermore, the light source 102 of the device 100 is mounted on top of a pedestrian crosswalk signal 104. However, the light source 102 can be mounted in any suitable place as is known in the art, as long as the light source 102 is visible to motorists driving by. Further, the light source 102 is mounted to the crosswalk signal 104 via any suitable securing means as is known in the art, such as screws, nails, glue, etc.

In a preferred embodiment of the device 100, the area illuminated extends the entire length of the crosswalk so that a motorist will be able to see pedestrians in the driver's lane, as well as pedestrians about to enter that lane. Further, the area is wider than the crosswalk in order to account for the height of pedestrians near the boundary of the crosswalk.

As shown in FIG. 5, the device 100 is adapted to be a portable device. The device 100 can be a stand-alone device that is solar-powered or battery-powered, thus allowing the device 100 to be transported where needed. This allows the device 100 to be used for additional services, and not just at a crosswalk. For example, the device can be used at a railroad crossing, in a construction zone, at a park, bike path, etc.

In another embodiment, the device 100 can include data storage circuitry 500 to collect additional data, such as the number of pedestrians activating the device 100, the direction of travel by the pedestrian and the number of vehicles approaching or passing by the device 100 by time of day. The inventive device 100 may include report generation capability which can be useful in determining how frequently the crosswalk is used and the heavy or light usage time periods. These capabilities can be expanded to include other data which the device 100 owner may find useful in preparing future strategies.

In yet another embodiment, the crosswalk light device 100 is typically manufactured from UV-stabilized plastic or polymers, such as polypropylene or acrylonitrile-butadiene-styrene (ABS), or any other suitable material as is known in the art, such as, but not limited to, acrylic, polycarbonate, polyethylene, thermoplastic, polyethylene terephthalate, polyvinyl chloride, polystyrene, metals, such as cast aluminum, stainless steel, etc. Generally, the crosswalk light device 100 is also manufactured from a material that is water resistant or water permeable, or the light source 102 comprises a coating that is water resistant or water permeable.

In another embodiment, the crosswalk light device 100 comprises a plurality of indicia 502. Specifically, the light source 102 of the device 100 may include advertising, a trademark, or other letters, designs, or characters, printed, painted, stamped, or integrated into the light source 102, or any other indicia 502 as is known in the art. Specifically, any suitable indicia 502 as is known in the art can be included, such as, but not limited to, patterns, logos, emblems, images, symbols, designs, letters, words, characters, animals, advertisements, brands, etc., that may or may not be crosswalk or safety/brand related.

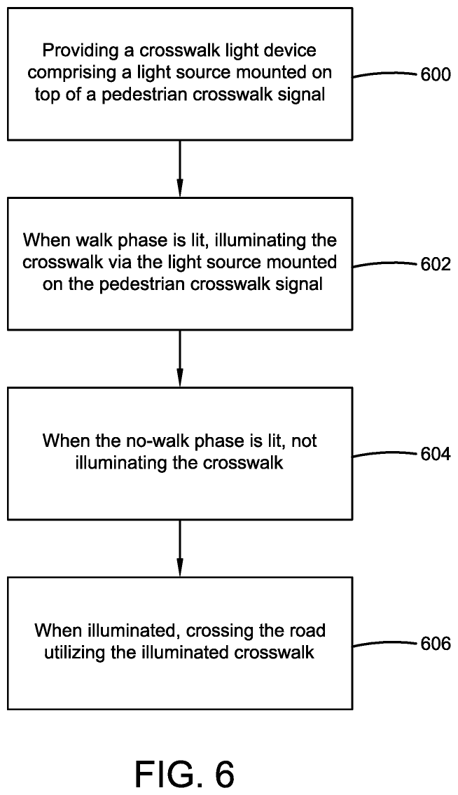

FIG. 6 illustrates a flowchart of the method of illuminating a crosswalk during nighttime hours for pedestrians to cross safely. The method includes the steps of at 600, providing a crosswalk light device comprising a light source mounted on top of a pedestrian crosswalk signal. The method also comprises at 602, when the walk phase is lit, illuminating the crosswalk via the light source mounted on the pedestrian crosswalk signal. Further, the method comprises at 604, when the no-walk phase is lit, not illuminating the crosswalk. Finally, at 606, when illuminated, crossing the road utilizing the illuminated crosswalk.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “crosswalk light device”, “light device”, and “device” are interchangeable and refer to the crosswalk light device 100 of the present invention.

Notwithstanding the foregoing, the crosswalk light device 100 of the present invention can be of any suitable size and configuration as is known in the art without affecting the overall concept of the invention, provided that it accomplishes the above-stated objectives. One of ordinary skill in the art will appreciate that the crosswalk light device 100 as shown in FIGS. 1-6 are for illustrative purposes only, and that many other sizes and shapes of the crosswalk light device 100 are well within the scope of the present disclosure. Although the dimensions of the crosswalk light device 100 are important design parameters for user convenience, the crosswalk light device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A crosswalk light device for maintaining roadway safety for both pedestrians and motorists, the crosswalk light device comprising:
a light source mounted on a pedestrian crosswalk signal;
wherein the light source illuminates a crosswalk area during a walking phase of the pedestrian crosswalk signal; and
further wherein the crosswalk light device detects a pedestrian entering the crosswalk area and activates the light source.

2. The crosswalk light device of claim 1, wherein the light source is activated by a manual control.

3. The crosswalk light device of claim 1, wherein the light source is activated automatically by a sensor.

4. The crosswalk light device of claim 1, wherein the sensor is an infrared detector system comprising an infrared light (IR) source, a reflector, and an IR detector.

5. The crosswalk light device of claim 4, wherein the IR source and the IR detector are positioned with respect to each other on one side of the crosswalk area, with the reflector positioned at an opposite side of the crosswalk area, such that an IR beam is directed across the crosswalk area to the reflector, and back to the IR detector.

6. The crosswalk light device of claim 5, wherein as the pedestrian steps into the crosswalk area, the IR beam is momentarily broken, thereby causing the IR detector to generate a signal that activates the light source.

7. The crosswalk light device of claim 1, wherein the light source is an LED floodlight.

8. The crosswalk light device of claim 1 further comprising a second light source that is positioned at an opposite end of the crosswalk area, such that at least a partial beam of light appears at each end of the crosswalk area.

9. The crosswalk light device of claim 1 further comprising an ambient light sensing circuit that adjusts a light intensity of the light source.

10. The crosswalk light device of claim 1 further comprising a light controller and a sensor, wherein the light source is controlled by the light controller that receives a signal from the sensor.

11. The crosswalk light device of claim 1, wherein the light source is solar-powered.

12. The crosswalk light device of claim 1, wherein the light source is battery powered.

13. The crosswalk light device of claim 1, wherein the crosswalk light device is timed to deactivate the light source after a predetermined interval of time.

14. A crosswalk light device for maintaining roadway safety for both pedestrians and motorists, the crosswalk light device comprising:
a light source activated by a manual switch or by a sensor; and
a light controller that receives a signal from the manual switch or the sensor and controls the light source;
wherein the light source is mounted on a top of a pedestrian crosswalk signal;
wherein the light source illuminates a crosswalk area during a walking phase of the pedestrian crosswalk signal;
wherein the crosswalk light device detects a pedestrian entering the crosswalk area and activates the light source for a predetermined interval of time; and
wherein a second light source is positioned at an opposite end of the crosswalk area, such that at least a partial beam of light appears at each end of the crosswalk area.

15. The crosswalk light device of claim 14 further comprising a data storage circuitry to collect a data from the crosswalk light device.

16. The crosswalk light device of claim 14 further comprising a plurality of indicia.

17. The crosswalk light device of claim 14, wherein the light source is an LED floodlight.

18. The crosswalk light device of claim 14, wherein the light source is solar-powered.

19. The crosswalk light device of claim 14, wherein the sensor is an infrared detector system comprising an infrared light (IR) source, a reflector and an IR detector.

20. A method of illuminating a crosswalk area for pedestrians to cross safely, the method comprising the steps of:
providing a crosswalk light device comprising a light source mounted on top of a pedestrian crosswalk signal;
illuminating the crosswalk area via the light source mounted on the top of the pedestrian crosswalk signal when a walk phase of the pedestrian crosswalk signal is illuminated;
failing to illuminate the crosswalk area when a no-walk phase of the pedestrian crosswalk signal is illuminated; and
crossing a road utilizing the illuminated crosswalk area when the light source is illuminated.
